(19) United States
(12) Patent Application Publication
(10) Pub. No.: US 2006/0286219 A1
(43) Pub. Date: Dec. 21, 2006

(54) Beverage container with pre-salted rim and method of production

(76) Inventors: Brandon L. Mauldin, Blanchard, OK (US); Amy C. Mauldin, Blanchard, OK (US)

Correspondence Address: JAMES T. ROBINSON, 222 E. MAIN STREET, NORMAN, OK, 73069, US

(21) Appl. No.: 11/150,060

(22) Filed: Jun. 10, 2005

(51) Int. Cl. A21D 10/02

(52) U.S. Cl. 426/112

(57) ABSTRACT

A beverage container having a pre-salted rim for use with alcoholic and non-alcoholic beverages provides a plastic beverage container having a rim and a solid substance attached to the rim by a food-grade adhesive. Another embodiment includes a potable beverage solution contained within the plastic beverage container and a seal simultaneously separating the potable beverage solution from the solid substance and forming a seal around the coated rim. A method for producing the beverage container with a pre-coated rim is also provided.

### BACKGROUND OF THE INVENTION

1. Field of the Invention

This invention relates to a beverage container with a pre-salted rim for alcoholic and non-alcoholic beverages. More particularly, but not by way of limitation, the invention provides a beverage container having margarita salt attached to the rim by a food-grade adhesive.

2. Discussion

A margarita is an alcoholic drink made, most commonly, from a lime-juice mix combined with measured quantities of tequila and triple sec. Over the last several years, margaritas have gained increased popularity in restaurants, drinking establishments, and homes. Margaritas are served either over ice or frozen. Most restaurants and bars utilize a machine which freezes and stores a quantity of frozen margaritas for easy dispensing into beverage containers. The margarita machine also reduces the time and labor required for a bartender to prepare a margarita.

Margaritas are commonly served in a beverage container whose rim has been coated with margarita salt, a coarse salt readily available at grocery stores, super markets, and food service companies. The bartender prepares the beverage container by slicing a lime, cutting a wedge from the sliced lime, rubbing the lime wedge around the rim of the beverage container to create a film of lime juice on the rim, and then dredging the juiced rim in a container of margarita salt.

Whereas the margarita machine reduces the labor to mix the drink, much labor is required to prepare the beverage container. A sharp knife is required to slice the lime, thereby creating an opportunity for an accidental cut. The margarita salt may become contaminated by other substances used behind the bar.

Margaritas are not the only alcoholic drinks commonly served in a beverage container having a salted rim. A salty dog (grapefruit juice and vodka or other liquor) is commonly served in a beverage container whose rim is salted, and some patrons prefer beer served in a similar container.

The present invention provides a beverage container having a coating of margarita salt attached securely to the rim by a food-grade adhesive. The pre-salted rim saves time for the bartender, ensures consistency and quality control, and eliminates the potential for contamination of the margarita salt.

### SUMMARY OF THE INVENTION

An object of the present invention is to provide a beverage container with a pre-salted rim for use in conjunction with frozen margaritas.

Yet another object of the present invention is to provide a beverage container with a pre-salted rim to reduce the labor required by a bartender to prepare the beverage container.

Another object of the present invention is to provide a method of production for preparing a beverage container with a pre-salted rim.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a view of applicant's beverage container invention showing margarita salt attached to the rim of the beverage container.

FIG. 2 is an enlarged view of the beverage container invention shown in FIG. 1 with the bottom portion of the beverage container cut away.

FIG. 3 illustrates a step in applicant's method of attaching the margarita salt to the rim of the beverage container.

FIG. 4 illustrates another step in applicant's method of attaching the margarita salt to the rim of the beverage container.

FIG. 5 illustrates another step in applicant's method of attaching the margarita salt to the rim of the beverage container.

FIG. 6 illustrates another step in applicant's method of attaching the margarita salt to the rim of the beverage container.

FIG. 7 illustrates another step in applicant's method of attaching the margarita salt to the rim of the beverage container.

FIG. 8 illustrates another step in applicant's method of attaching the margarita salt to the rim of the beverage container.

FIG. 9 illustrates another step in applicant's method of attaching the margarita salt to the rim of the beverage container.

FIG. 10 is a cross-sectional view of the pre-coated rim of applicant's beverage container invention.

FIG. 11 is another cross-sectional view of the rim of applicant's beverage container invention.

FIG. 12 shows a potable liquid contained within applicant's beverage container invention,

FIG. 13 is a cross-sectional view of the rim of applicant's beverage container invention of FIG. 12 wherein the margarita salt is generally.

FIG. 14 is another cross-sectional view of the rim of applicant's beverage container invention of FIG. 12.

### DETAILED DESCRIPTION OF THE INVENTION

In the following description of the invention, like numerals and characters designate like elements throughout the figures of the drawings.

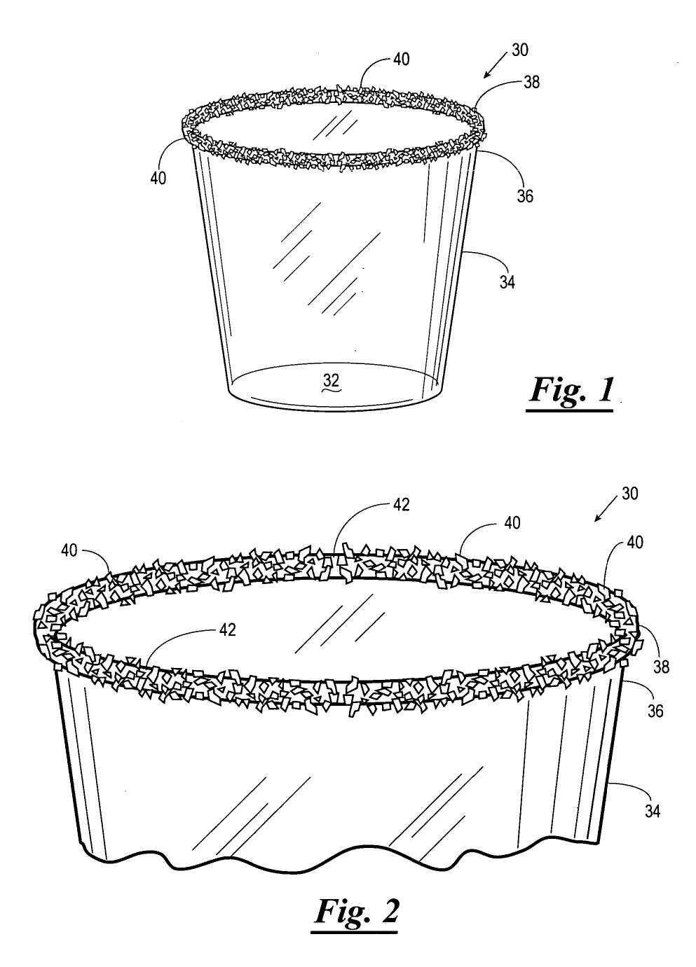

Referring generally to the drawings and more particularly to FIGS. 1 and 2, a beverage container 30 has a bottom 32 and an upstanding wall 34 having an upper portion 36. The upstanding wall 34 terminates in a rim 38. Margarita salt particles 40 are retained on the rim 38 by a coating of food-grade adhesive 42 (See FIGS. 10-11).

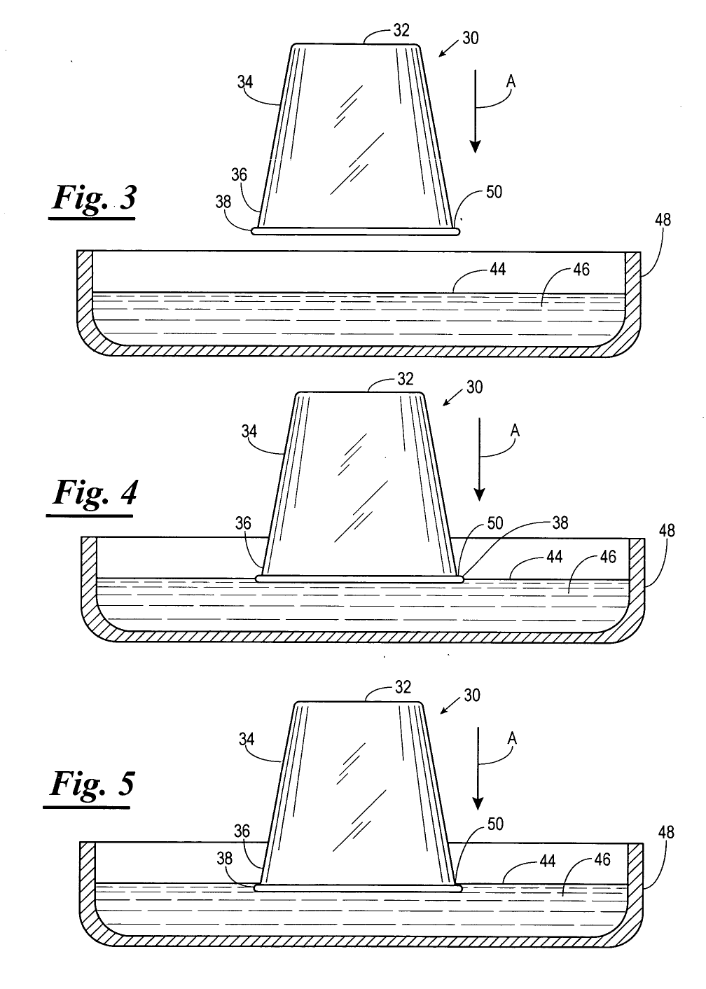

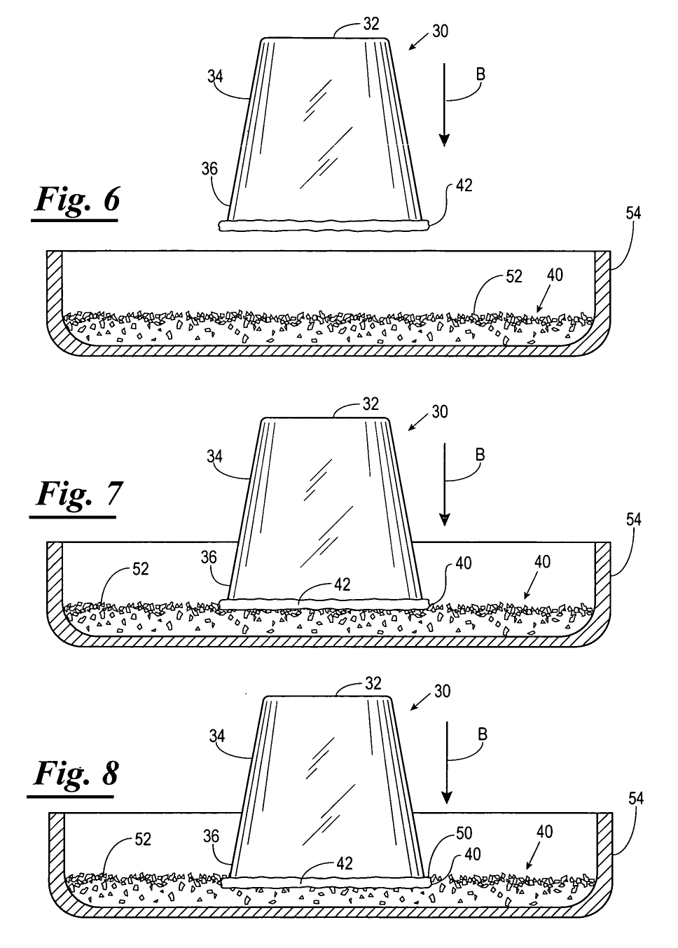

Referring now to FIGS. 3-9, the process of producing the beverage container with pre-salted rim is shown in detail. FIGS. 3-5 illustrate the application of the coating of food-grade adhesive 42 to the rim 38 of the beverage container 30, and FIGS. 6-9 illustrate the application of the margarita salt particles 40 to the food-grade adhesive coating 42 on the rim 38.

Still referring to FIGS. 3-9 and to FIG. 3 in particular, the inverted beverage container 30 is moved downwardly along A, thereby causing the rim 38 to approach the surface 44 of a food-grade adhesive coating solution 46 contained in a reservoir 48.

Referring now to FIG. 4, the inverted beverage container 30 is directed along A until the rim 38 is uniformly in contact with the surface 44 of the food-grade adhesive coating solution 46. As a result of the contact between the rim 38 and the food-grade adhesive coating solution 46, a layer of food-grade adhesive coating 42 is applied to the rim 38.

Referring now to FIG. 5, the inverted beverage container 30 is further directed along A until the rim 38 is immersed slightly below the surface 44 of the food-grade adhesive coating solution 46. The immersion of the rim 38 in the food-grade adhesive coating solution 46 results in application of a coating of the food-grade adhesive solution 46 to the rim 38 of the beverage container 30. Due to the immersion of the rim 38, the coating of food-grade adhesive 42 is also applied to the underside 50 of the rim 38.

Although the food-grade adhesive coating 46 is referred to for convenience as a solution, it will be understood by one skilled in the art that the food-grade adhesive coating 46 solution may also take the form of a colloidal suspension or a gel.

Referring now to FIGS. 6-9 and to FIG. 6 in particular, the inverted beverage container 30, with a still-wet coating 42 of the food-grade adhesive coating solution 46 on the rim 38, is moved downwardly along B, thereby causing the coated rim to approach the surface 52 of the margarita salt particles 40 contained in a reservoir 54.

Referring now to FIG. 7, the inverted beverage container 30, with a still-wet coating 42 of the food-grade adhesive coating solution 46 on the rim 38, is directed along B until the coated rim is uniformly in contact with the margarita salt particles 40 contained in the reservoir 54. As a result of the contact between the still-wet coated rim 38 and the margarita salt particles 40, a layer of margarita salt 40 is applied to the still-wet coating 42 of food-grade adhesive coating solution 46.

Referring now to FIG. 8, the inverted beverage container 30 is further directed along B until the coated rim is immersed slightly below the surface 52 of the margarita salt particles 40. Contact of the coated rim with the margarita salt particles 40 results in application of a layer of margarita salt 40 to the coated rim of the beverage container 30. Due to the immersion of the coated rim below the surface 52 of the margarita salt particles 40, margarita salt particles 40 are also applied to the underside 50 of the coated rim.

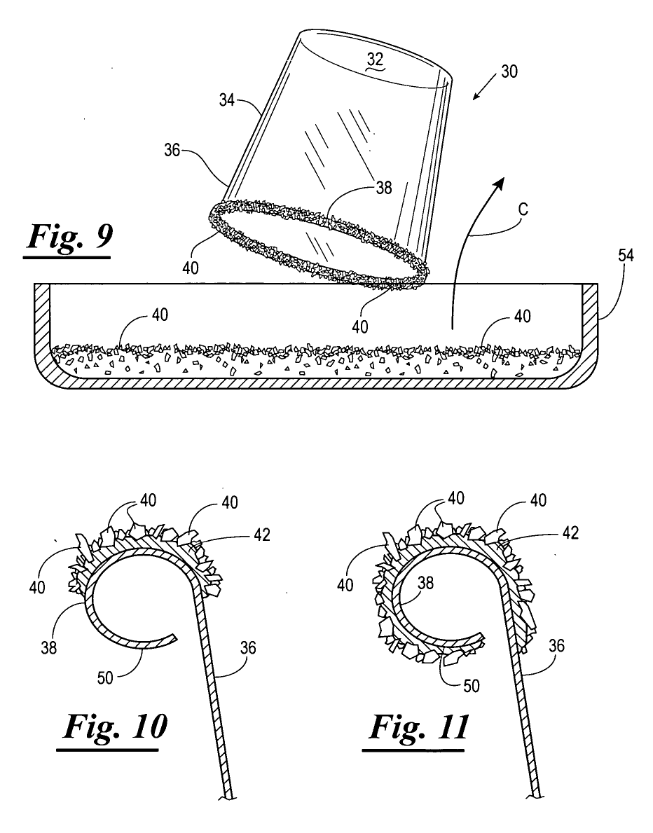

Referring now to FIG. 9, the beverage container 30, with a layer of margarita salt 40 attached to the still-wet coating 42 of the food-grade adhesive coating solution 46 on the rim 38, is removed from the margarita salt container 54 as indicated by arrow C and set aside. Within a few minutes, the coating 42 of food-grade adhesive dries, thereby securing the margarita salt particles 40 to the rim 38 of the beverage container 30.

Referring now to FIGS. 10 and 11, a greatly enlarged cross-section of the upper portion 36 of the upstanding wall 34 of the beverage container 30 shows a coating 42 of food-grade adhesive on the rim 38 of the beverage container 30 and a layer of margarita salt 42 attached to the coating 42. In FIG. 10, a relatively thinner coating of margarita salt 40 is shown, consistent with preparation according to the steps illustrated in FIG. 4 and FIG. 7. In FIG. 11, a relatively thicker coating of margarita salt 42 on the rim 38 results from preparation according to the steps illustrated in FIG. 5 and FIG. 8.

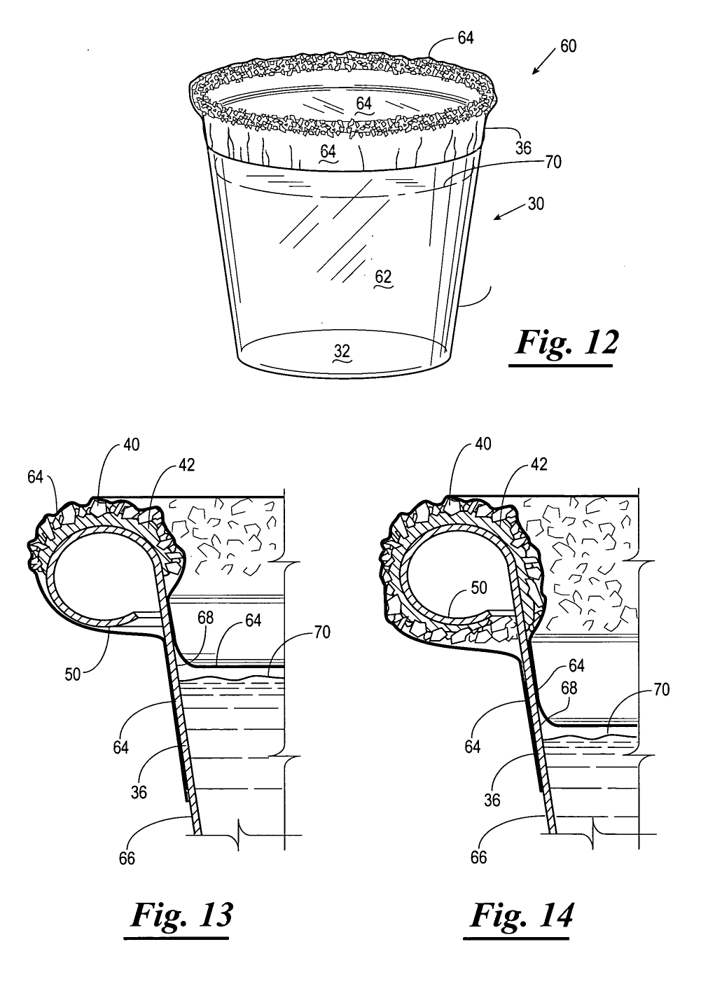

Referring now to FIGS. 12-14, a ready-to-use beverage serving 60 contains a beverage solution 62 within the beverage container 30. A seal 64 encloses the outside 66 of the upper portion 36 of the upstanding wall 34 of the beverage container 30, the coated rim 38 bearing the margarita salt particles 42, and the inside 68 of the upper portion 36 of the upstanding wall 34 above the surface 70 of the beverage solution 62. The seal 64 thus separates the beverage solution 62 from the margarita salt particles 40 and the food-grade adhesive coating 42. The user can freeze the ready-to-use beverage serving 6Q and then remove the seal 64 for consumption. In the alternative, the user can remove the seal 64 and add ice to the beverage solution 62 for immediate consumption.

Food-grade substances which can be used to create the food-grade adhesive solution include guar gum, agar, xanthan gum, and gelatin. Guar gum, which is well known in the food industry, is sold as a white to yellowish odorless white powder. Guar gum is available in different viscosities and different granulometries depending on the desired viscosity. Guar's viscosity is a function of temperature, time, and concentration. One advantageous property of guar gum is that it thickens without the application of heat.

Xanthan gum is mainly considered to be non-gelling and used for the control of viscosity. It hydrates rapidly in cold water without lumping to give a reliable viscosity. Xanthan's most important property is its very high low-shear viscosity coupled with its strongly shear-thinning character. The relatively low viscosity at high shear means it is easy to mix, pour, and swallow but its high viscosity at low shear gives good suspension and coating properties

Like xanthan gum, agar is a hydrocolloid gum commonly used in food and beverage formulations. Agar (also referred to as agar-agar) produces a firm and brittle gel.

Gelatin has been used in food products for many years. Unlike guar gum and xanthan gum, gelatin normally requires low heat (less than about 140 degrees Fahrenheit) to dissolve (i.e., for hydration and thickening). Commercially available flavored gelatin products found in supermarkets and grocery stores include a preservative such as butylated hydroxytoluene (BHT), an antioxidant which preserves color and taste. If not already available in the gelatin, a preservative should be added to the food-grade adhesive coating solution according to applicant's invention. Likewise, a preservative should be added if the food-grade adhesive coating solution utilizes guar, xanthan, or agar.

Some people object to the use of gelatin obtained from animals. A soy-based gelatin-like material has been created from water, fructose, high-gelling soy protein and a carrageenan (a seaweed). Called NuSoy Gel, the vegetable-based gelatin substitute can also be used to secure the margarita salt to the rim of the beverage container.

Traditional hard candies can also be used for the food-grade adhesive coating, although the high temperatures required to maintain a liquid form prevent the use of hard candy solutions with typical plastic beverage containers.

The beverage container 30 illustrated herein can be plastic, glass, paper, expanded foam, or ceramic. For backyard pool use, plastic, paper, or expanded foam will be preferred due to safety considerations. On more formal occasions, a glass or ceramic beverage container can be used to prepare the beverage container with pre-salted rim.

The present invention has been described in the context of a beverage container with a pre-salted rim as might be used for margaritas and salty dogs. The present invention also includes beverage containers with other components in the place of margarita salt. Other materials which could be attached to the rim by a food-grade adhesive coating include, by way of illustration and not by way of limitation, sugar sprinkles (for children's drinks), chopped nuts, and a cocoa-sugar mixture (for hot cocoa or coffee).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of producing a beverage container having a rim pre-coated with salt, the method comprising the steps of:
providing a food-grade adhesive solution in a first reservoir, wherein the food-grade adhesive solution is characterized as having a surface;
providing a supply of margarita salt in a second reservoir;
inverting the beverage container so that the rim of the beverage container is oriented downwardly just above the surface of the food-grade adhesive solution in the first reservoir;
moving the beverage container downwardly until the rim of the beverage container makes uniform contact with the surface of the food-grade adhesive solution and the rim of the beverage container becomes coated with the food-grade adhesive solution;
moving the beverage container upwardly away from the surface of the food-grade adhesive solution while maintaining the beverage container in the inverted position;
moving the beverage container downwardly until the coated rim of the beverage container makes uniform contact with the margarita salt and the margarita salt adheres to the coated rim of the beverage container;
moving the beverage container upwardly away from the margarita salt; and
restoring the beverage container to a normal upright position at room temperature until the food-grade adhesive dries.

2. The method of claim 1 wherein the food-grade adhesive solution consists of gelatin dissolved in water.

3. The method of claim 1 wherein the food-grade adhesive solution consists of xanthan gum dissolved in water.

4. The method of claim 1 wherein the food-grade adhesive solution consists of agar dissolved in water.

5. The method of claim 1 wherein the food-grade adhesive solution consists of guar gum dissolved in water.

6. The method of claim 2 wherein the gelatin is kosher gelatin.

7. The method of claim 1 wherein the food-grade adhesive solution consists of a mixture of water, fructose, high-gelling soy protein, and carrageenan.

8. A method of producing a beverage container having a rim pre-coated with a flavored solid substance, the method comprising the steps of:
providing a food-grade adhesive solution in a first reservoir, wherein the food-grade adhesive solution is characterized as having a surface:
providing a supply of the solid substance in a second reservoir;
inverting the beverage container so that the rim of the beverage container is oriented downwardly just above the surface of the food-grade adhesive solution in the first reservoir;
moving the beverage container downwardly until the rim of the beverage container makes uniform contact with the surface of the food-grade adhesive solution and the rim of the beverage container becomes coated with the food-grade adhesive solution;
moving the beverage container upwardly away from the surface of the food-grade adhesive solution while maintaining the beverage container in the inverted position;
moving the beverage container downwardly until the coated rim of the beverage container makes uniform contact with the solid substance and the solid substance adheres to the coated rim of the beverage container;
moving the beverage container upwardly away from the solid substance; and
restoring the beverage container to a normal upright position at room temperature until the food-grade adhesive dries.

9. The method of claim 8 wherein the food-grade adhesive solution consists of gelatin dissolved in water.

10. The method of claim 8 wherein the food-grade adhesive solution consists of xanthan gum dissolved in water.

11. The method of claim 8 wherein the food-grade adhesive solution consists of agar dissolved in water.

12. The method of claim 8 wherein the food-grade adhesive solution consists of guar gum dissolved in water.

13. The method of claim 9 wherein the gelatin is kosher gelatin.

14. The method of claim 8 wherein the food-grade adhesive solution consists of a mixture of water, fructose, high-gelling soy protein, and carrageenan.

15. The method of claim 8 wherein the solid substance further comprises sugar sprinkles.

16. The method of claim 8 wherein the solid substance further comprises a mixture of sugar and cocoa.

17. The method of claim 8 wherein the solid substance further comprises chopped nuts.

18. The device of claim 8, wherein the beverage container is a paper cup.

19. The device of claim 8, wherein the beverage container is made of glass.

20. The device of claim 8, wherein the beverage container is made of plastic.

21. The device of claim 8, wherein the beverage container is made of ceramic.

22. A beverage container having a pre-coated rim for use with alcoholic and non-alcoholic beverages, the beverage container comprising:
a plastic beverage container having a rim;
a solid substance; and
means for attaching the solid substance to the rim of the plastic beverage container.

23. A ready-to-use beverage serving, comprising:
a plastic beverage container having a rim adjacent an upper portion of the plastic beverage container;
a potable beverage solution contained within the plastic beverage container so that the surface of the potable beverage solution remains below the upper portion of the plastic beverage container;
coarse salt;
means for attaching the coarse salt to the rim of the plastic beverage container so the coarse salt extends around the rim; and
sealing means for simultaneously forming a seal around the interior of the plastic beverage container below the upper portion of the plastic beverage container and forming a seal around the coated rim to protect the coated rim from contamination.
